(19) United States
(12) Patent Application Publication
(10) Pub. No.: US 2012/0210841 A1
(43) Pub. Date: Aug. 23, 2012

(54) Method and system for more accurately determining nutritional values and reducing waste of food items

(75) Inventors: Greg T. Getzinger, Hudson, OH (US); Andrew Raymond Spriegel, Massillon, OH (US)

(73) Assignee: NuVo Grand, LLC, Hudson, OH (US)

(21) Appl. No.: 12/932,296

(22) Filed: Feb. 22, 2011

(51) Int. Cl. B26D 3/24; A47J 47/00

(52) U.S. Cl. 83/821; 269/295

(57) ABSTRACT

A method of utilizing a food cutting guide that has a base having a circular first and circular second planar surface. The guide has a plurality of grooves formed in at least one of the planar surfaces and at least one centering guide formed on the at least one of the planar surfaces to facilitate cutting equal size slices and/or sections of food. A wider angled guide groove is formed at the end of each of the plurality of grooves. At least one centering groove/mark is concentric about an intersection of the plurality of grooves to center a pizza or food item. The cutting guide comprises at least one handle. A guide material comprises food safe and/or NSF approved plastic, wood and plastic composites, bamboo, wood, ash, hickory, oak, walnut, maple, purple heartwood, chestnut, cherry; plastic, porcelain, metal, stone, wood composite materials, glass, porcelain, bamboo, recycled paper composite, countertop material, plastic composite materials, and food safe materials; wherein the cutting guide first and second planar surfaces have enough friction so that protrusions are not necessary to stabilize the equal size slices and/or sections of food during cutting.

### FIELD OF THE INVENTION

The invention relates generally to a method and system involving a food cutting guide and more particularly to a method and system for utilizing the food cutting guide to cut approximately equal size food sections which ensure the food section's nutritional values are approximately equal, reducing waste of food sections and thereby increasing food section sales and sales profits.

### BACKGROUND OF THE INVENTION

Public and private schools, sports teams, booster clubs, children party centers, hospitals, nursing homes and institutions all have a need for pizzas and/or food items which are cut into equal slices for lunch programs, meals, fund raisers, and the like. When there are equal slices, there are fewer leftovers due to odd shapes or undersized or oversized slices. Thus, there is a need for a cutting guide to ensure that different size diameter pizzas (e.g., an 8 or 14 inch diameter pizza) can be cut into approximately equal size slices.

There is also a need for determining the nutritional values of the food items, reducing waste of the food items and increasing profits of food item sales.

Various prior art attempts have been made to develop products for cutting food items/segments/portions into equal slices and/or shapes. Some of those prior art devices have focused on a guide that holds the pizza, while others have focused on prior art devices for cutting the pizzas. However, all of those prior art attempts have various limitations and disadvantages, and the present invention provides an improvement over these prior art devices.

Some prior art devices have pointed protrusions, for example molded into the guide so that the pizza is held by the protrusions during the cutting process. However, these protrusions would hamper sliding the pizza off of the guide into a delivery box as often is required.

Further, nutritional studies indicate that many popular foods eaten in the US are wedge-shaped (e.g., pizza, cakes, and pies), and these foods affect the amount of saturated fat and sugar that are consumed by individuals and that they are associated with degenerative health conditions. Thus, it is important that amounts of wedge-shaped and other food sizes reported in food consumption surveys be as accurate as possible (See e.g., Journal of the American Dietetic Association, Mar. 14, 2006). However, the according to many scientific articles, standard techniques for measuring portion sizes of wedge shaped foods are often inaccurate and therefore the invention discussed herein can be used to eliminate many of those inaccuracies.

Notwithstanding these prior art devices for cutting equal pizza slices and related applications, there remains a need for method and system for determining nutritional values, reducing the waste of food items and increasing profits in the sale of food items utilizing an equal slice cutting device, and the like.

### RELATED APPLICATIONS

This application claims priority to U.S. Provisional Application Ser. No. 61/339,139 filed Feb. 22, 2010, entitled “METHOD AND SYSTEM FOR MORE ACCURATELY DETERMINING NUTRITIONAL VALUES AND REDUCING WASTE OF FOOD ITEMS”.

### SUMMARY OF THE INVENTION

Accordingly, the present invention overcomes the limitations of the prior art by providing a method and system for more accurately determining nutritional values, reducing waste of food items and increasing profits by reducing waste of food items. The method and system utilize a unique and useful cutting guide/board having a system of grooves and concentric guides and a method for cutting equal size wedge or pie shaped, rectangular shaped, diamond shaped, and the like, slices of pizza, cake, pie, etc., for example. The cutting board of the present invention is such that it is simple to construct, relatively inexpensive to make and to use, easy to clean between uses, allows the centering of the pizza or food item on the cutting board and many'other advantages mentioned below.

Consequently, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

It is an object of the present invention to provide a method and system for more accurately determining nutritional values of food items.

It is a further object of this invention to provide a method and system for reducing waste of food items.

It is an object of the present invention to provide a method and system for increasing profits of food items by cutting the food item into approximately equal sizes to eliminate the potential rejection of smaller food items.

It is yet another object of this invention to provide a method and system for increasing profits from the sale of food items.

It is an object of the present invention to provide a cutting guide for increasing profits of food items by cutting the food item into approximately equal sizes and to allow the food to be easily slid off of the guide into a delivery box or serving platter.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIGS. 1A, 1B and FIG. 2 illustrate a pizza cutting guide/board having slots and grooves and a food cutting device/guide according to an embodiment of the invention;

FIG. 3 is a flow diagram illustrating an exemplary method and system for approaching organizations to help them more accurately determine nutritional values and reduce waste of food items utilizing the food cutting guide; and

FIGS. 4-6 is a flow diagram illustrating an exemplary method and system for approaching concession sales managers to help them more accurately determine nutritional values, reduce waste of food items and increase profits utilizing the food cutting device.

### DETAILED DESCRIPTION OF THE INVENTION

One or more implementations of the present invention will now be described with reference to the attached drawings, wherein like reference numerals are used to refer to like elements throughout. The invention relates generally to a method and system for more accurately determining nutritional values of food items and reducing waste of food items which results in larger profits. The method and system utilize a proportional cutting device/guide for cutting pizzas, pies, cakes, and suitable foods into equal proportions.

The cutting guide of the present invention can be used with a variety of cutting utensils, and so is not limited to any particular cutting utensil, for example, a roller blade, a knife, a rocker knife, and the like. The guide also can be used as a two sided pizza guide, for example, with various number of grooves on each one or both side, of the guide, and so does not require a user to have separate pizza guides (for example, comprising a six slice side, a ten slice side, a sixteen slice side).

In addition, the method and system will be described with respect to concession sales and institutional sales; however it also applies to events and/or groups comprising fund raisers, pizza shops, pizza franchises, wedding planners, restaurants, hospitals, channels of dealers/distributors, schools, universities, nursing homes, caterers, and other groups that sell food items, known by those of skill in the art.

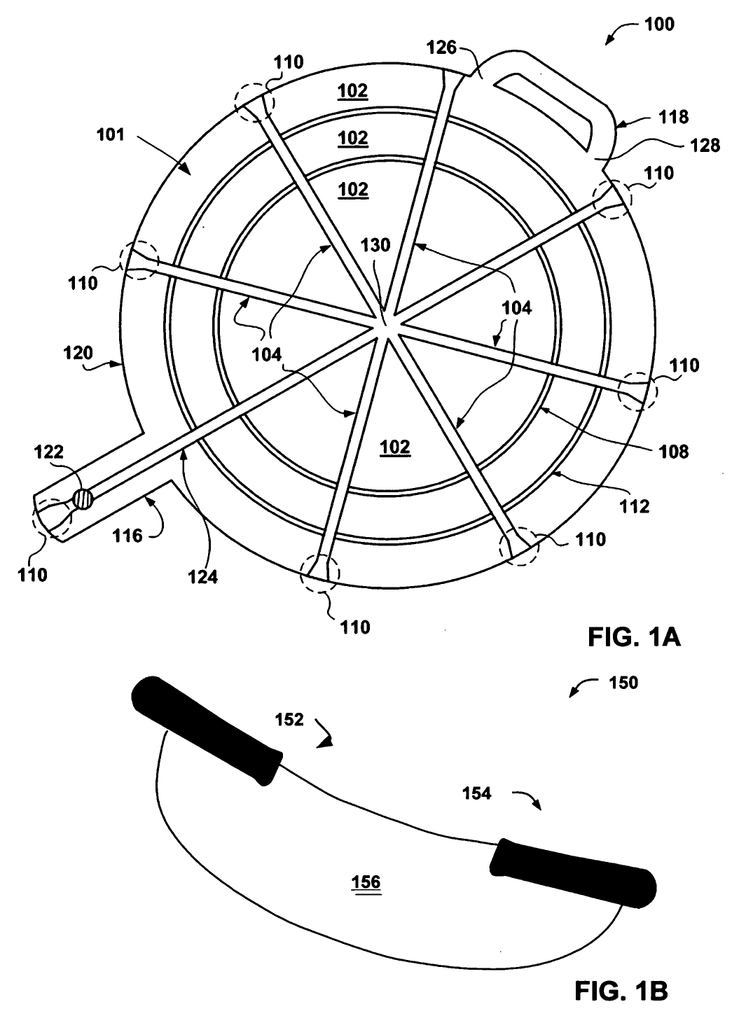

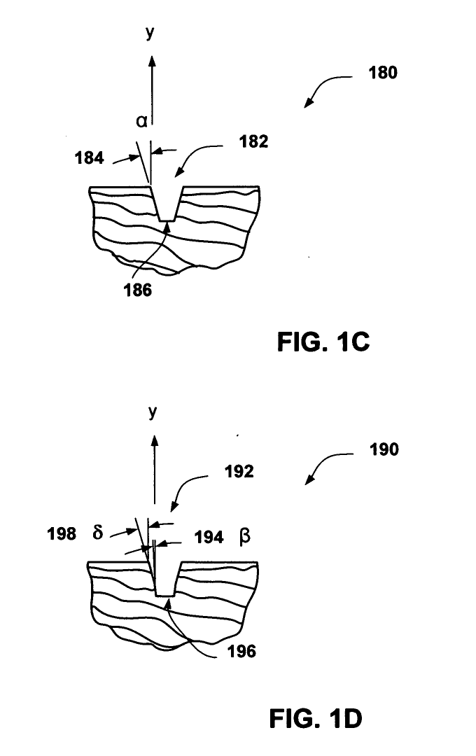

As seen in FIG. 1A, the present invention consists of a flat, circular guide body 120, although as discussed herein as wedge shaped 101 the guide body 120 can include other shaped groves comprising triangles, diamonds, rectangles, and the like. In this embodiment, the guide body 120, for example, can have a principal handle 116 and an optional supplemental handle 118. The body 120 has a plurality of grooves 104 to facilitate cutting of the pizza (for example) and a guide groove 124 which is placed in the principal handle 116 to facilitate the beginning of the cutting process which leads to the equal proportioning of the food product. Although the body 120 is illustrated as a circular shape it can have any shape known by one of those of skill in the art, comprising an oval shape, a rectangular shape, and the like. In addition, although the grooves are shown ending at the outer edge of the board the groove could be formed within the confines of the body 120, away from the outer edge of the body 120.

In one embodiment illustrated in FIG. 1A, a pizza (not shown) can be placed on a first planar surface 102 of a proportional cutting guide 100 and a cutting tool 150 can be used to slice and/or cut the pizza into equal pie-shaped segments as desired. The cutting tool 150 can be, for example, a handle held pizza cutting wheel, a knife, a multiple handle rocker pizza blade (a shown), and the like. Beveled slots and/or cutting grooves 104, 108, 112, and 124, in FIG. 1A, for example, are formed, cut, routed, marked, or a combination thereof, and the like, into the first planar surface 102 of the guide 100 allowing the cutting tool 150 to cut through the pizza.

The circular centering slots 108 and 112 allow a user to center the pizza on the first planar surface 102 so that a pizza center and a device center 130 are properly aligned. The circular centering slots 108 and 112 are slightly larger in diameter than the diameter of the pizza to be cut. For example, if the pizza to be cut is 8 inches in diameter the circular centering slot may be approximately 8.25 inches in diameter. Once sliced, the pizza may be served on the guide 100 or slid off onto a serving plate, platter, tray, cardboard delivery box, and the like. Although the circumferential slots are illustrated as being continuous, dashed or interrupted circumferential slots can be formed in the board to properly center the pizza. In addition, although the segments 101 are show as equal they can be two or more different sizes, for example, one slice large for adults and one

In addition, though not shown letters or numbers can be cut, laser etched, and the like to indicate the diameter size in inches, millimeters, etc., at that location, for example. In addition, directions, recipes, artwork, cooking instructions, quotes, messages, individual names, company logos, and the like, can be cut, laser etched, burned, etc. into the first planar surface 102, or a second planar surface (not shown) of the proportional cutting guide 100. Also, the slots and/or grooves can be replaced by parallel ridges, elevated guides, and the like, and fall within the scope of this invention.

The inventor(s) recognize that prior art pizza boards had slotted grooves that intersected at a central point on the pizza board; however with the prior art boards it was still possible to cut unequal slices of pizza, if the pizza center is not properly aligned with respect to the guide's center. Therefore, by adding the concentric circles mentioned supra, the inventor(s) ensured that the pizza is properly centered in order to cut approximately equal sections of pizza and provide the proportioning suggested for dietary control.

In this embodiment, the guide 100 is approximately circular in shape and may be constructed from a variety of materials comprising wood, such as ash, hickory, oak, walnut, maple and purple heartwood, chestnut, cheery; plastic, porcelain, metal, stone, wood composite materials, bamboo, recycled paper composite, Corian®, plastic composite materials, food safe materials and the like. The guide 100 can be manufactured utilizing a variety of techniques comprising CNC machining, routing, injection molding, rotational molding, blow molding, and the like.

The guide 100 has a pair of substantially flat planar surfaces with the first planar face 102 and a second planar face (not shown) parallel to the first planar face 102. Although the device is described with parallel faces the inventor(s) contemplated non-parallel planar surfaces and such embodiments are considered part of this invention so that the upper facing surface is at an angle when the device is sitting flat on a table. The diameter of the guide 100 is sufficiently large to accommodate the pizza to be cut or proportioned. For example, the guide 100 may be large enough to accommodate pizzas ranging from four to sixteen inches in diameter. In addition, slots, marking and the like can be made on one or both planar surfaces, and the markings, slots and the like can be the same or different on either planar surface. In other words, the first planar surface can be used to cut eight approximately equal slices whereas the second planar surface can be used to cut approximately ten equal slices.

The guide 100 is sufficiently thick (e.g., ¼, ⅜ and ½ inches thick) so that the guide 100 remains substantially rigid after slots or cutting grooves 104, 108, 112, and 124 are created in the first planar surface 102 and/or the second planar surface (not shown) of the guide 100. The guide 100 shown in FIG. 1A is substantially uniform, however, the guide 100 of varying thickness designed to reduce weight, material costs, and the like would still be within the scope of the invention. In other words, the portion of the guide 100 where the cutting grooves are located could be the thickest portion of the guide 100 wherein the flanged portion between the cutting grove portions can have material removed so that the pizza remains relatively flat, such as honeycombed, grooves and the like and can be easily slid off the guide 100. In addition, through holes (i.e., lightening holes), and the like can be formed by removing material or molding the device to lighten the board for the end user. In addition, a very lightweight composite, such as an aluminum honeycomb sandwiched between two layers of material (e.g., plastic, composite, bamboo, etc.) could be utilized and all such devices are encompassed in the scope of this invention.

In the embodiment shown in FIG. 1A the first handle 116 is approximately rectangular in shape that can be utilized as a hand grip and a second handle 118 is offset from the first handle 116 and the second handle 118 connects to the guide 100 in two places 126 and 128. The first handle 116 and the second handle 118 can be offset (in other words not centered on the same line bisecting the circle) so they are not 180 degrees apart from the intersection's center 130, as shown, to allow the user to balance the guide 100 holding a pizza, for example, and thus prevent tipping. However, the guide may include a plurality of handles of a variety of shapes and sizes designed to support the weight of the pizza and still be within the scope of the invention. The handles 116, 118 may be continuous with the device 102 as shown in FIG. 1A, or they may be detachable and fastened with any known commercial fastening technique known to those skilled in the art such as glue, joints, fasteners, screws, nails, dowels, and the like. The handles 116, 118 may also be made of a different material than the device 102 and remain within the scope of the invention. For example, the device could be maple and the handle black walnut. In addition, the device could be a lamination of various materials including wood, plastic, composites, bamboo and the like.

The guide 100 illustrated in FIG. 1A is further defined by cutting slots or cutting grooves 104, 124 that each bisect the approximately circular surface of the first planar surface 102 with an approximate outer circumference 120. The slots 104, 124 extend into the guide 100 a sufficient depth, for example one eighth of an inch, to allow the cutting tool to completely cut through the pizza placed on the first planar surface 102. FIG. 1A shows four slots 104 and 124 to cut eight approximately equal pieces of pizza but is not intended to be a limit on a number of the slots formed in the guide 100. The slot 124 bisects the first planar surface 102 running longitudinally through a center of the first handle 116. In addition, the handle 116 has a through hole 122 for hanging the device from a hook, for example or for attaching a cord, leather strap, etc.

The inventor(s) recognized that by extended the slot 124 onto the handle 116 it would aid in making the initial bisecting cut of the pizza because the cutting tool can be easily located on handle slot 124. The initial slot non-fixedly holds the pizza to the first planar surface 102 because the pizza forced into the slot 124 during the cutting process prevents from the pizza from rotating during subsequent cutting operations. In addition, by having the slot 124 extend into the handle 116 it is easier to locate and begin the cutting process thereby speeding up the process when compared other prior art devices.

FIG. 1B illustrates a two handle 152, 154 rocker cutting tool 150 that can be used in conjunction with the proportional cutting guide 100 mentioned supra. The inventor(s) recognized that by using the cutting tool 150 with a curvilinear blade, for example, that when the cutting tool blade 206 comes into contact with the pizza it does so with a tangential or point load that is a larger load that is applied to the pizza at any given cutting location to cut the slice completely through, as opposed to some of the prior art devices mentioned supra. Alternatively, other types of cutting tools may be employed and are contemplated as falling within the scope of the present invention, e.g., knives, cutting roller wheels, etc.

FIG. 1B illustrates the two handle rocker cutting tool 150 that can be used in conjunction with the proportional cutting guide 100 mentioned supra. The inventor(s) recognized that by using the cutting tool 150 with a curvilinear blade that when the cutting tool blade 156 comes into contact with the pizza it does so with a tangential or point load that is a larger load that is applied to the pizza at any given cutting location to cut the slice completely through, as opposed to some of the prior art devices mentioned supra.

FIG. 1C further describe the slots/grooves 104, 124 illustrated in FIG. 1A, with another embodiment 180 wherein a slot 182 with a beveled edge where the angle α 184 is, for example, approximately between 5 and 10 degrees and the bottom of the slot 186 is cut parallel with respect to the first planar surface 102 (FIG. 1A).

FIG. 1D illustrates yet another embodiment 190 of a slot/groove 192 as having a compound angle with angle β 194, located adjacent to the bottom of the slot 196, and angle γ (gamma) 198, closest to the first planar surface 102, measured from the vertical y axis, as shown, where the total combined angle is between 5 and 15 degrees, for example. The scope of this invention includes slots of other shapes and sizes including a continuous curve, various arcs, compound angles, concave shapes and the like. One skilled in the art recognizes that when a blade is directed toward the bottom of a slot and away from the side edges it thereby reduces the wear on the device/guide, as illustrated in the prior art devices, for example, where the side walls of the groove are parallel.

Routing, cutting and making grooves of various sizes and shapes is well know by those of skill in the art and all such sizes and shapes are contemplated and part of this invention.

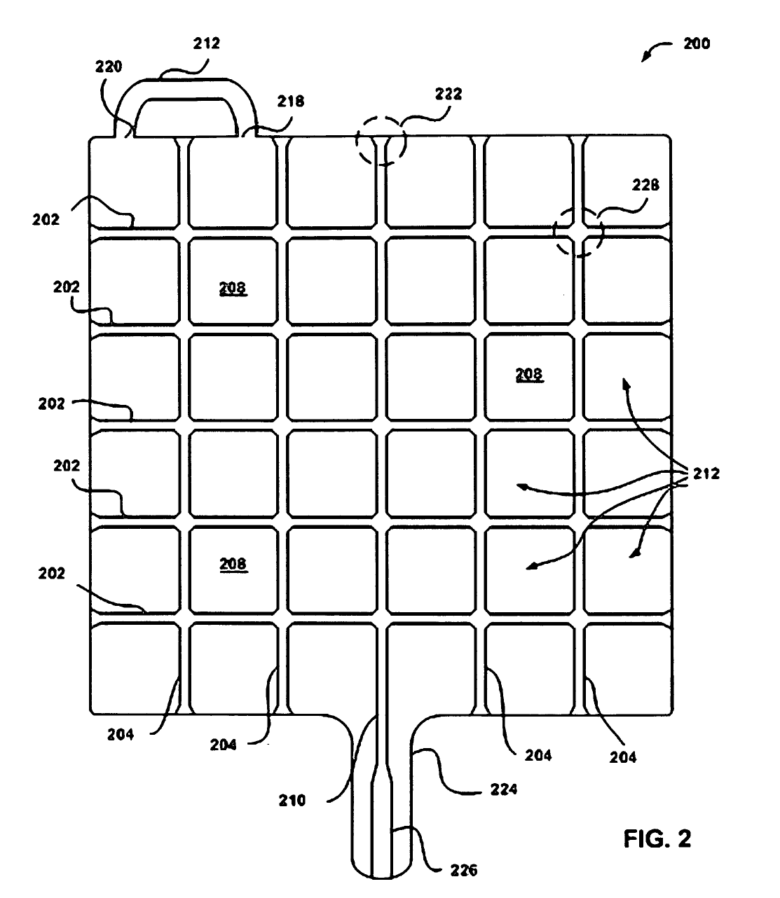

FIG. 2 illustrates an approximately rectangular slot design where a first planar surface 208, has a plurality of slots 202, 204 and 210 in the first planar surface wherein the plurality of slots 202 and 204/210 are substantially perpendicular to each other and the parallel plurality of slots 202 and/or 204/210 are equally spaced apart. The plurality of slots 202, 204 and 210 allows the user to subdivide the pizza into a plurality of substantially equal-sized square shaped pizza slices 212. For example, the slots 202, 204 and 210 may be cut into the first planar surface 208 at, for example, four inch intervals creating portions that are four inch square. While this embodiment teaches this design, the scope of the invention is not limited to parallel and perpendicular slots of equal spacing. Any desirable slot design may be created in a planar surface of any shaped device such as other geometric or decorative shapes including diamonds, triangles, rectangles, and the like. Additionally, the shape of the proportional cutting device may be circular, square, rectangular, or any other shape desirable to a user. A bevel 222 can be cut, routed and the like into the beginning of the slots 202 and 204 to guide the cutting tool more easily into the slots 202 and 204. In addition, an elongated beveled slot 226 can be formed into a first handle 224 so that the cutting tool is more easily guided toward the pizza, for example thereby causing less or eliminated premature wear on the device 200. A second handle 212 can be formed as part of the device 200 attaching to the device 200 at a first location 220 and a second location 218, for example.

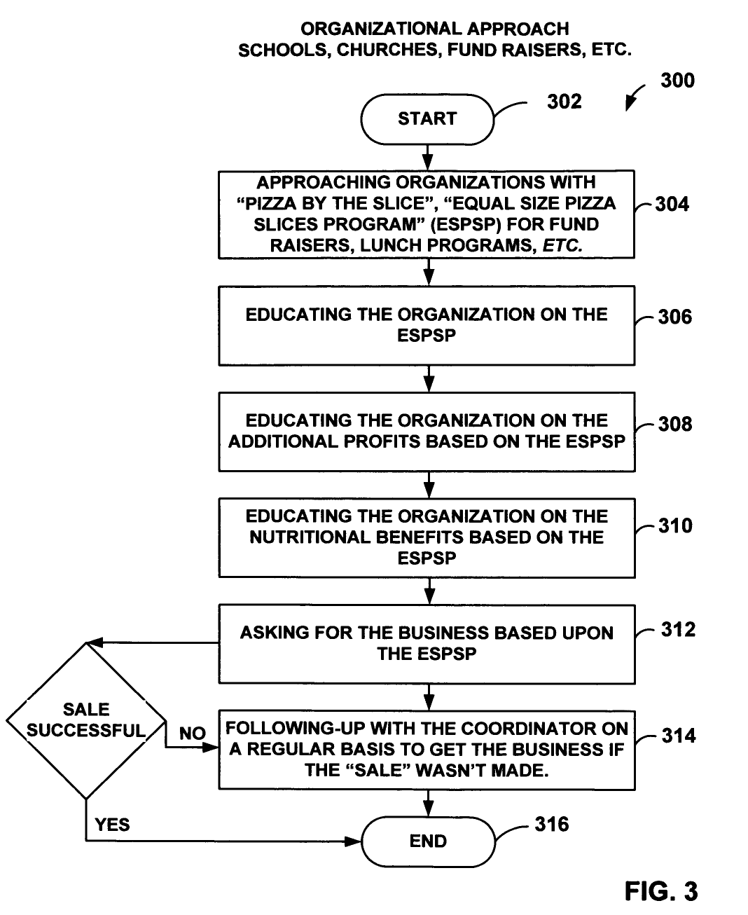

Illustrated in FIG. 3 is a method 300 and system for more accurately determining nutritional values, reducing waste of food items and increasing profits based on the reduced waste which results in larger profits to various individuals, businesses, non-profit organizations, for-profit organizations, and the like. The exemplary method 300 can utilize a proportional cutting guide 100 (FIG. 1A) for cutting a pizza, for example, into approximately equal size slices, according to one or more aspects of the present invention. The method will be described with respect to FIGS. 1A-1D and FIG. 2. These embodiments are described in sufficient detail to enable those skilled in the art to practice the invention, and it is to be understood that the embodiments may be combined or that other embodiments may be utilized and that changes may be made to the invention without departing from the spirit and scope of the present invention.

The exemplary method 300 may be advantageously employed in association with pizza; however the method is not limited to pizza but applies to cakes, pies and other suitable food items. The method 300 begins at 302, wherein at 304 an individual/pizza promoter, such as a pizza shop owner, a pizza franchise general manager, approaches an organization, for example, with a “pizza by the slice” program for fund raisers wherein the pizza promoter's business purchases and resells equal size slices of pizza.

At 306 the pizza promoter/seller/franchise, for example, can approach a local private school with the goal to meet with a food service coordinator. At 306 the pizza promoter should determine whether the food service coordinator already has a current pizza provider and if she/he does it is critical to determine what problems the food service coordinator is having with the current pizza provider. If the private school has a current pizza provider at 306 the promoter/seller/franchise should educate the food service coordinator or organization on the numerous benefits involving the “equal size pizza slices program” (ESPSP) for fund raisers, lunch programs, etc., for example increased profits, better understanding of nutrients, etc.

The method 300 proceeds to 308 wherein the pizza promoter determines if there are pizza portion problems. Even if the food service coordinator says there is not a problem with portion size this is the point when the pizza promoter shows the proportional cutting guide 100 and discusses the reduced food waste benefits resulting in increased profits. If the coordinator does not know the profit numbers, this is the time to educate them on the profit potential of the program. Do not be surprised if the coordinator has no idea of what the profits are on pizza sales. What follows is an exemplary profit analysis based upon four 14 inch diameter pizzas cut into 8 equal slices; however various diameter pizzas as well as various numbers of slices are contemplated herein.

For example, this example illustrates a profitable venture to sell pizza by the slice for lunch on Fridays, to the students. In order to maximize the profits it is critical to cut the pizza into approximately equal size slices. It has been shown that smaller pieces of pizza in a pizza pie will often not be purchased or avoided, thereby resulting in waste of food, having to be thrown away and loss of profits because those smaller pieces cannot be sold. The wasted food and the loss in profits can be substantial over time.

The method 300 proceeds to 310, where the pizza promoter determines if the coordinator is satisfied with the profit from sales of the pizza. If the coordinator is satisfied the promoter asks the coordinator for the pizza business at 312.

If the sale is not successful, the promoter should follow-up with the coordinator on a regular basis to get the business if the “sale” wasn't made.

A major advantage of the “pizza by the slice” program is that nutritional studies indicate that many popular foods eaten in the US are wedge-shaped (e.g., pizza, cakes, and pies), and these foods affect the amount of saturated fat and sugar that are consumed and that they are associated with degenerative health conditions. Thus, it is important that amounts of wedge-shaped foods reported in food consumption surveys be as accurate as possible (See e.g., Journal of the American Dietetic Association, Mar. 14, 2006). However, the standard techniques for measuring portion sizes of wedge shaped foods are often inaccurate and therefore the method 300 discussed herein can be used to eliminate those issues. One has only to look at Michele Obama's program on fighting childhood obesity to understand how important it is to be able to measure size portions properly and therefore determine nutritional content, calories, and the like.

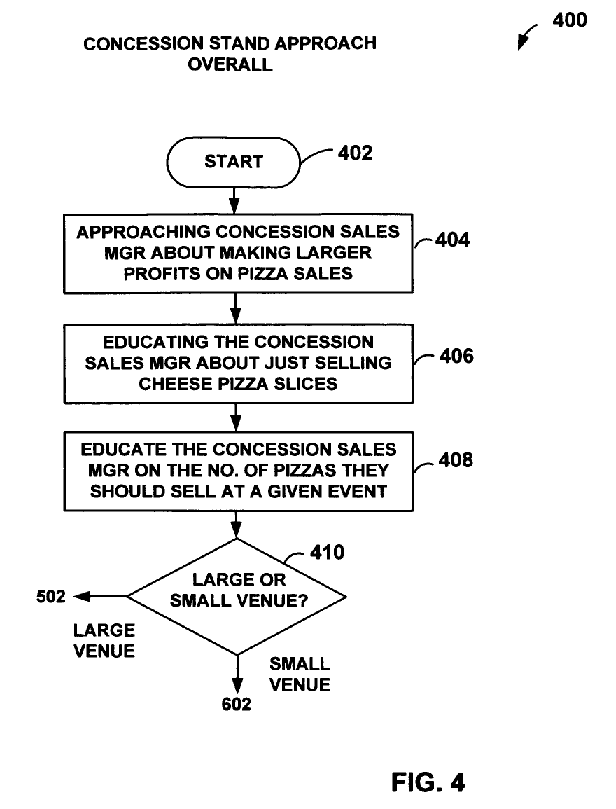

Illustrated in FIG. 4 is a method 400 and system for promoting the “pizza by the slice” program for driving profits at concession stand sales. Many if not most concession stands are run by parents of students that are volunteering their time. They often do not know how much pizza to order, what is a good price point to sell pizza slices and how much to pay for pizza pies. The method 400 begins at 402 and at 404 a pizza promoter approaches a concession stand manager/parent regarding a fundraiser. The decision maker is most often not the person manning the concession stand. Treat concession stand sales as a commercial account and consult with the decision maker on how many pizzas to order and how much they will make in profit per pizza. Pizza by the slice can be one of the most profitable items sold at the concession stand. If done properly by the promoter's business the fundraiser does not have to worry about making the pizza, cutting the pizza, picking up the pizza, waste or leftovers, rather the decision maker/concession manager can focus on cash flow and profits.

At 406 the promoter should convince the concession sales manager to just sell cheese pizza slices rather than other pizza combinations, e.g., cheese and pepperoni, etc. Concession stands frequently offer cheese and pepperoni and other combinations by the slice at the concession stand, but simpler is better and more profitable and that means selling cheese only pizzas. If you try to sell cheese and pepperoni; and cheese pizzas, for example, it is inevitable that one or the other will run out first. After running out of one item, anticipating how much to order for the remainder of the game will more than likely, result in left over pizza and additional costs for delivery and tip charges.

At 408 the promoter needs to educate the concession sales manager on the number of pizzas they should sell at a given event. At 410 the promoter needs to determine whether venue is large or small concession venue.

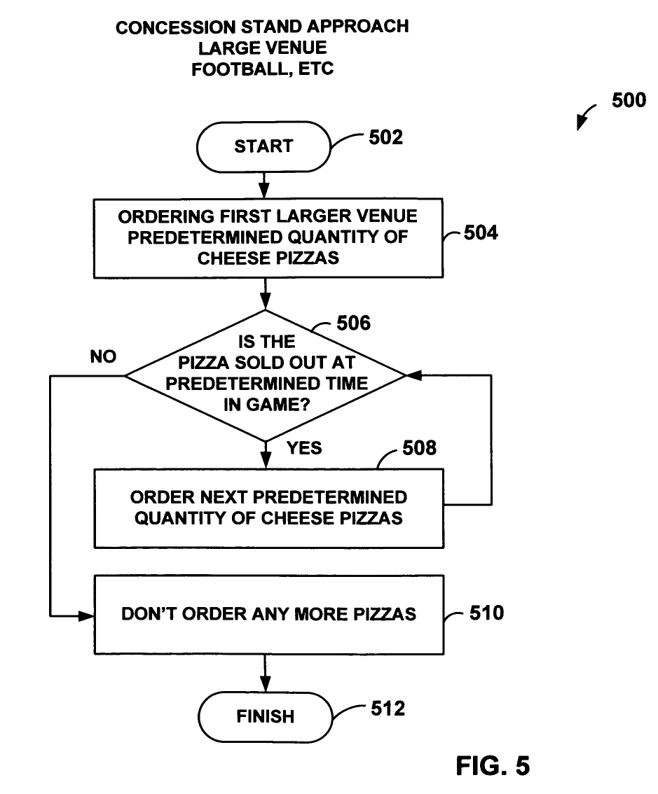

If the venue is large the method 400 proceeds to FIG. 5 wherein method 400 continues as method 500. Larger venues typically involve larger sports events, like high school football games. At first be conservative in the number of pizzas ordered and offer some convenience services. If feasible purchase a large insulated bag which will cost approximately one hundred dollars. The large insulated bag should hold up to fifteen fourteen inch diameter pizzas. Lend the concession stand personnel a warmer for the evening so the concessions can keep their pizzas warm throughout the game. Offer to include or recommend that the fundraiser purchase a roller blade cutter to cut the pizzas. Even though the equal slice cutting tool will cut equal slices at the pizza shop, for example, it's natural for the cheese to glaze over, in other words the cheese runs together and has to be separated, as the pizza cools and the cheese needs to be separated with the roller cutter. With the bag warmer the promoter can recommend a larger order. The method 500 begins at 502 and at 504 for the first game, start with an order of ten pizzas, for example. If the pizzas sell out early at 506 at a predetermined time, then re-order five more pizzas. If the pizza is not sold out at 508 and there is not enough time to sell more pizza, do not buy any more pizza at 510 and the method ends at 512. This will reduce the delivery and tip charges, reduce losses and maximize profits for the larger concession stand venue. Understand, the initial sales/games will be fact finding events. It will take a while to get the numbers right.

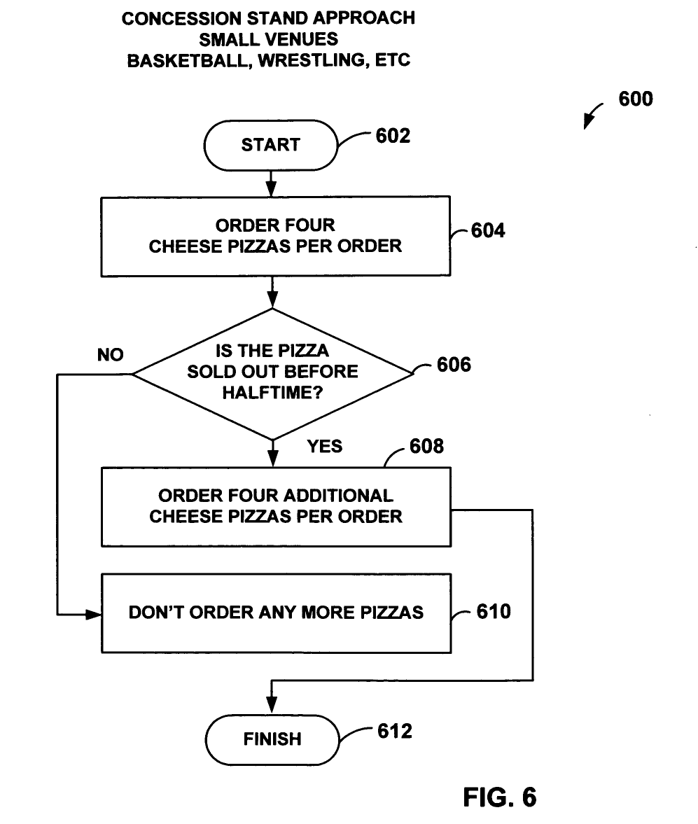

If the venue is small proceed to FIG. 6 where method 400 continues at method 600 and begins at 602. Smaller concession venues are typically basketball and wrestling, for example, and for the small concession venue start out with four total pizzas per the first order at 604, for example. If the four pizzas sell out before the game is half over at 604, order four more at 608. On the other hand, if they last through half the game at 606, don't order more at 610 and the method ends at 612. When they sell out, they sell out, let the fundraiser make the profit and help them limit their losses. That way you will create a long term, satisfied customer that will help you generate long term profits.

After a few games the promoter and the fundraiser will have a greater feeling for ordering. Keep in mind, weather conditions may play into the pizza sales. Rain and snow means less people will attend which means fewer slices of pizza will be sold.

Although the invention has been illustrated and described with respect to one or more embodiments, implementations, alterations, and/or modifications may be made to the illustrated examples without departing from the spirit and scope of the appended claims. In particular regard to the various functions performed by the above described components or structures (assemblies, devices, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”. “includes”, “having”, “has”, “with”, or variants thereof are used in either the detailed description and the claims, such terms are intended to be inclusive in a manner similar to the term “comprising”.

What is claimed is:

1. A food cutting guide comprising:
a base having a circular first and circular second planar surface with a plurality of grooves formed in at least one of the planar surfaces and at least one centering guide formed on the at least one of the planar surfaces to facilitate cutting equal size slices and/or sections of food; and
wherein a wider angled guide groove is formed at the end of each of the plurality of grooves;
wherein the at least one centering groove/mark is concentric about a intersection of the plurality of groves;
wherein the cutting guide comprises at least one handle;
wherein a guide material comprises food safe and/or NSF approved plastic, wood and plastic composites, bamboo, wood, ash, hickory, oak, walnut, maple, purple heartwood, chestnut, cherry; plastic, porcelain, metal, stone, wood composite materials, glass, porcelain, bamboo, recycled paper composite, countertop material, plastic composite materials, and food safe materials;
wherein the cutting guide first and second planar surfaces have enough friction so that protrusions are not necessary to stabilize the equal size slices and/or sections of food during cutting.

2. The food cutting guide of claim 1, wherein the plurality of cutting grooves facilitate cutting equal size slices and/or sections of food; and
wherein the food comprise pizza, pies, cakes, tortillas and quesadillas;
wherein the guide can be branded and/or marked comprising laser etching, branding and pad printing.

3. The food cutting guide of claim 1, wherein the plurality of grooves comprise grooves formed into the guide, compound angle cutting grooves, raised parallel ridges, various angle grooves.

4. The food cutting guide of claim 1, wherein the proportional cutting guide is custom made based upon a customer's specifications, wherein the specifications comprise a first number of a plurality of grooves formed on the first planar surface, a second number of a plurality of grooves formed on the second planar surface, a groove dimension, a selected material, a first number and diameter of concentric marks formed on the first planar surface, a second number and diameter of concentric marks formed on the second planar surface.

5. The cutting guide 100 of claim 1, wherein at least one of the flat surfaces has a plurality of grooves which intersect to subdivide the surface into a plurality of sized food segments;
wherein the segments comprise pie-shaped, square, rectangular and triangular shapes;
wherein the food comprise pizza, pies, cakes, tortillas and quesadillas.

6. The food cutting guide of claim 1, wherein the guide is optionally branded and/or marked comprising laser etching, branding and pad printing.

7. The food cutting guide of claim 1, wherein the plurality of grooves formed into the guide comprise, angular grooves, compound angle cutting grooves, raised parallel ridges and various angle grooves.

8. The food cutting guide of claim 1, wherein the proportional cutting guide is custom made based upon a customer's specifications, wherein the specifications comprise a first number of a plurality of grooves formed on the first planar surface, a second number of a plurality of grooves formed on the second planar surface, a groove dimension, a selected material, a first number and diameter of concentric marks formed on the first planar surface, a second number and diameter of concentric marks formed on the second planar surface.

9. The food cutting guide device of claim 1, wherein the device is custom made based upon a customer's specifications, wherein the specifications comprise a first number of a plurality of grooves formed on the first planar surface and a second number of a plurality of grooves formed on the second planar surface, segments sizes and shapes, the number of segments formed on the first planar surface and the number of segments formed on the second planar surface.

10. A method of increasing food sales utilizing a food cutting guide; comprising:
(a) approaching organization with equal size pizza slices program (ESPSP) utilizing a food cutting guide;
(b) educating the organization on the ESPSP;
(c) educating the organization on the additional profits from ESPSP;
(d) educating the organization on the nutritional benefits of ESPSP;
(e) asking for the business based upon the ESPSP;
(f) going to (h) if the sale is successful;
(g) following-up with the coordinator on a regular basis and return to (f), and
(h) ending the process.

11. The method of claim 10 wherein explaining the includes the explanation of a pizza cutting guide and advantages;
wherein a first advantage the cutting guide comprises facilitating cutting equal size sections of food;
wherein a second advantage the cutting guide comprises facilitating the equal size sections of food contain approximately the same amount of nutrients;
wherein a third advantage the cutting guide comprises facilitating the equal size sections thereby reducing wasted food;

12. The method of claim 10, wherein the cutting guide comprising:
a base having a circular first and circular second planar surface with a plurality of grooves formed in at least one of the planar surfaces and at least one centering guide formed on the at least one of the planar surfaces to facilitate cutting equal size slices and/or sections of food; and
wherein a wider angled guide groove is formed at the end of each of the plurality of grooves;
wherein the at least one centering groove/mark is concentric about a intersection of the plurality of groves;
wherein the cutting guide comprises at least one handle;
wherein a guide material comprises food safe and/or NSF approved plastic, wood and plastic composites, bamboo, wood, ash, hickory, oak, walnut, maple, purple heartwood, chestnut, cherry; plastic, porcelain, metal, stone, wood composite materials, glass, porcelain, bamboo, recycled paper composite, countertop material, plastic composite materials, and food safe materials;
wherein the cutting guide first and second planar surfaces have enough friction so that protrusions are not necessary to stabilize the equal size slices and/or sections of food during cutting.

13. The method of claim 10, wherein the plurality of cutting grooves facilitate cutting equal size slices and/or sections of food; and
wherein the food comprise pizza, pies, cakes, tortillas and quesadillas;
wherein the guide can be branded and/or marked comprising laser etching, branding and pad printing;
wherein the guide is custom made based upon a customer's specifications, wherein the specifications comprise a first number of a plurality of grooves formed on the first planar surface, a second number of a plurality of grooves formed on the second planar surface, a groove dimension, a selected material, a first number and diameter of concentric marks formed on the first planar surface, a second number and diameter of concentric marks formed on the second planar surface.

14. The method of claim 10, wherein the food cutting guide of claim 1, wherein the plurality of grooves formed into the guide comprise, angular grooves, compound angle cutting grooves, raised parallel ridges and various angle grooves.

15. A method of increasing food sales profits utilizing a food cutting guide;
comprising:
(a) approaching concession sales mgr about making larger profits on pizza sales;
(b) educating the concession sales mgr about just selling cheese pizza slices;
(c) educating the concession sales mgr on the no. of pizzas they should sell at a given event;
(d) going to (m) if it is a large venue else go to (o);
(e) ordering first larger venue predetermined quantity of cheese pizzas;
(f) determining if the pizza is sold out at predetermined time in the larger venue game and if yes go to (g) else go to (j);
(g) order second larger venue predetermined quantity of cheese pizzas;
(h) suspending ordering any more pizzas;
(i) going to (n);
(j) ordering first smaller venue predetermined quantity of cheese pizzas;
(k) determining if the pizza is sold out at predetermined time in the smaller venue game and if yes go to (l) else go to (m);
(l) order second larger venue predetermined quantity of cheese pizzas;
(m) suspending ordering any more pizzas;
(n) ending the process.

16. The method of claim 15 wherein explaining the includes the explanation of a pizza cutting guide and advantages;
wherein a first advantage the pizza cutting guide comprises facilitating cutting equal size sections of food;
wherein a second advantage the pizza cutting guide comprises facilitating the equal size sections of food contain approximately the same amount of nutrients;
wherein a third advantage the pizza cutting guide comprises facilitating the equal size sections thereby reducing wasted food;

17. The method of claim 15, wherein food cutting guide comprising: a base having a circular first and circular second planar surface with a plurality of grooves formed in at least one of the planar surfaces and at least one centering guide formed on the at least one of the planar surfaces to facilitate cutting equal size slices and/or sections of food; and
wherein a wider angled guide groove is formed at the end of each of the plurality of grooves;
wherein the at least one centering groove/mark is concentric about a intersection of the plurality of groves;
wherein the cutting guide comprises at least one handle;
wherein a guide material comprises food safe and/or NSF approved plastic, wood and plastic composites, bamboo, wood, ash, hickory, oak, walnut, maple, purple heartwood, chestnut, cherry; plastic, porcelain, metal, stone, wood composite materials, glass, porcelain, bamboo, recycled paper composite, countertop material, plastic composite materials, and food safe materials;
wherein the cutting guide first and second planar surfaces have enough friction so that protrusions are not necessary to stabilize the equal size slices and/or sections of food during cutting.

18. The method of claim 15, wherein the plurality of cutting grooves facilitate cutting equal size slices and/or sections of food; and
wherein the food comprise pizza, pies, cakes, tortillas and quesadillas;
wherein the guide can be branded and/or marked comprising laser etching, branding and pad printing;
wherein the guide 100 is custom made based upon a customer's specifications, wherein the specifications comprise a first number of a plurality of grooves formed on the first planar surface, a second number of a plurality of grooves formed on the second planar surface, a groove dimension, a selected material, a first number and diameter of concentric marks formed on the first planar surface, a second number and diameter of concentric marks formed on the second planar surface.

19. The method of claim 15, wherein the plurality of grooves formed into the guide comprise, angular grooves, compound angle cutting grooves, raised parallel ridges and various angle grooves.

20. The method of claim 15, wherein the cutting guide first and second planar surfaces have enough friction so that protrusions are not necessary to stabilize the equal size slices and/or sections of food during cutting.
